(19) United States
(12) Patent Application Publication
(10) Pub. No.: US 2026/0252632 A1
(43) Pub. Date: Aug. 27, 2026

(54) DEVICE AND METHOD OF INTERACTION FOR SEARCHING AND ORGANIZING VAST PAPERS WITH NODE-LINK DIAGRAM

(71) Applicant: Korea Advanced Institute of Science and Technology, Daejeon (KR)

(72) Inventors: Seok-Hyung BAE, Daejeon (KR); Donghyeok MA, Daejeon (KR); Joon Hyub LEE, Daejeon (KR); Junwoo YOON, Daejeon (KR); Taegyu JIN, Daejeon (KR)

(73) Assignee: Korea Advanced Institute of Science and Technology, Daejeon (KR)

(21) Appl. No.: 19/651,506

(22) Filed: Apr. 17, 2026

Related U.S. Application Data
(63) Continuation of application No. PCT/KR2024/015824, filed on Oct. 17, 2024.

(30) Foreign Application Priority Data
Oct. 20, 2023 (KR) 10-2023-0140830
Oct. 15, 2024 (KR) 10-2024-0140120

(51) Int. Cl. G06F 16/904; G06F 3/0482; G06F 3/04845; G06F 16/93; G06T 11/26

(52) U.S. Cl. CPC G06F 16/904; G06F 3/0482; G06F 3/04845; G06F 16/93; G06T 11/26; G06T 2200/24

(57) ABSTRACT

The present disclosure relates to a user interaction device and method for searching and organizing vast papers with a node-link diagram. The device is configured to display at least one first node respectively representing at least one first paper, display a second node representing a desired paper generated by a user and at least one link respectively representing a citation relationship between the at least one first paper and the desired paper between the at least one first node and the second node, search for at least one second paper corresponding to the citation relationship as the desired paper, and collect the at least one second paper in the second node.

### CROSS-REFERENCE TO RELATED APPLICATIONS

This U.S. non-provisional application is a continuation application of PCT International Application PCT/KR2024/015824, which has an international filing date of October 17, 2024, and claims priorities under 35 U.S.C. 119 to Korean Patent Application No. 10-2023-0140830 filed on October 20, 2023 and Korean Patent Application No. 10-2024-0140120 filed on October 15, 2024, in the Korean intellectual property office, the disclosures of which are herein incorporated by reference in its entirety.

### BACKGROUND

### 1. FIELD

The present disclosure relates to an interaction device and method for searching and organizing vast papers with a node-link diagram.

### 2. DESCRIPTION OF RELATED ART

A researcher writes a related research section to explain what existing research their own research is based on, what differences exist from them, and how they contribute to academia through this. To this end, the researcher typically investigates hundreds of papers for several weeks to several months and expresses the relationships between studies in writing while citing dozens of papers. A representative method of investigating related papers is to find a seed paper determined to have high relevance to one’s own research and exhaustively investigate papers cited by the seed paper and papers citing the seed paper. Through this, it is possible to find from old papers to new papers related to the corresponding research topic. However, the number of papers cited by a single paper is usually dozens, and the number of papers citing a single paper exceeds hundreds if there are many. As the above process is repeated, the amount of papers to be reviewed increases exponentially, and due to this, one may feel uneasy about possibly missing an important paper, feel overwhelmed as papers to be read pile up like a mountain, and easily feel frustrated because a big picture formed by numerous papers is not seen.

### SUMMARY

The present disclosure provides an interaction device and method for searching and organizing vast papers with a node-link diagram.

In the present disclosure, an operating method of an electronic device may include displaying at least one first node each representing at least one first paper, displaying a second node representing a desired paper generated by a user and at least one link each representing a citation relationship of the at least one first paper and the desired paper between the at least one first node and the second node, searching for at least one second paper conforming to the citation relationship as the desired paper, and collecting the at least one second paper in the second node.

In the present disclosure, an electronic device may include a display module, an input module for detecting a user input, and a processor connected to the display module and the input module and configured to interact with a user through the display module and the input module, and the processor may be configured to display at least one first node each representing at least one first paper, display a second node representing a desired paper generated by the user and at least one link each representing a citation relationship of the at least one first paper and the desired paper between the at least one first node and the second node, search for at least one second paper conforming to the citation relationship as the desired paper, and collect the at least one second paper in the second node.

In the present disclosure, in a computer program stored in a non-transitory computer-readable recording medium for executing a method of expressing cited papers with a node-link diagram in an electronic device, the method may include displaying at least one first node each representing at least one first paper, displaying a second node representing a desired paper generated by a user and at least one link each representing a citation relationship of the at least one first paper and the desired paper between the at least one first node and the second node, searching for at least one second paper conforming to the citation relationship as the desired paper, and collecting the at least one second paper in the second node.

According to the present disclosure, the electronic device may search for a desired paper from a seed paper, that is, at least one second paper from at least one first paper, with a node-link diagram based on an interaction with a user, and organize the at least one first paper and the at least one second paper with the node-link diagram. Therefore, the electronic device may generate the node-link diagram based on the at least one first paper and the at least one second paper. Thereby, the user may accurately and easily grasp the at least one second paper as the desired paper without omission through the node-link diagram, and accurately and easily grasp a big picture formed by the at least one first paper and the at least one second paper. Additionally, the electronic device may easily edit the node-link diagram based on the interaction with the user.

### BRIEF DESCRIPTION OF THE DRAWINGS

FIG. 1 is a block diagram illustrating an electronic device according to various embodiments;

FIG. 2 is a block diagram illustrating a method of operating an electronic device according to various embodiments;

FIG. 3 is an exemplary view illustrating the step of displaying at least one first node of FIG. 2;

FIG. 4A, FIG. 4B, and FIG. 4C are exemplary views illustrating the step of displaying at least one of a second node or a keyword, and at least one first link of FIG. 2;

FIG. 5A, FIG. 5B, FIG. 5C, FIG. 5D, and FIG. 5E are exemplary views illustrating the step of searching for at least one second paper of FIG. 2;

FIG. 6A is an exemplary view illustrating the step of collecting at least one second paper in the second node of FIG. 2;

FIG. 6B and FIG. 6C are exemplary views illustrating the step of displaying a third node and at least one second link of FIG. 2; and

FIG. 7A, FIG. 7B, FIG. 7C, and FIG. 7D are exemplary views illustrating the step of editing the node-link diagram of FIG. 2.

### DETAILED DESCRIPTION

Hereinafter, various embodiments of the present disclosure will be described with reference to the accompanying drawings.

Hereinafter, an object of the present disclosure is to help a researcher easily and quickly find and organize relationships between existing studies that advantageously need to be grasped when writing a related research section. The present disclosure follows a workflow designed with inspiration from people leaving ideas in their heads as brief sketches first before they volatilize. When a researcher (also referred to as a user) briefly sketches a desired paper, an electronic device grasps the intention and completes the user’s sketch into a node-link diagram composed of actual papers and citation relationships. Such a node-link diagram plays three important roles in finding and organizing a vast amount of papers. First, through a graph query search, the node-link diagram enables finding a new related paper with various citation conditions right on the spot at any time while organizing papers. Second, through a node of the diagram expressing the first page of the paper as a thumbnail, the node-link diagram enables checking specific contents and memos of the paper right on the spot together with the diagram representing the overall big picture. Third, by selecting and visualizing only a desired one among various citation relationships of the paper and directly arranging it at a desired place, the node-link diagram enables utilizing spatial memory and continuously expanding one’s own related research landscape.

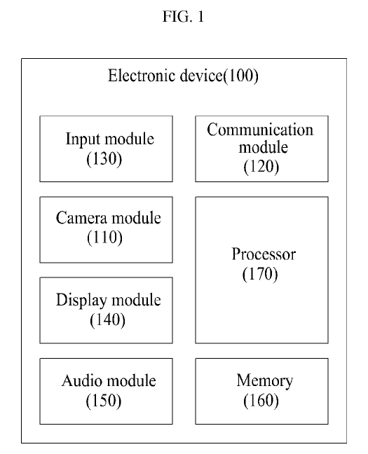

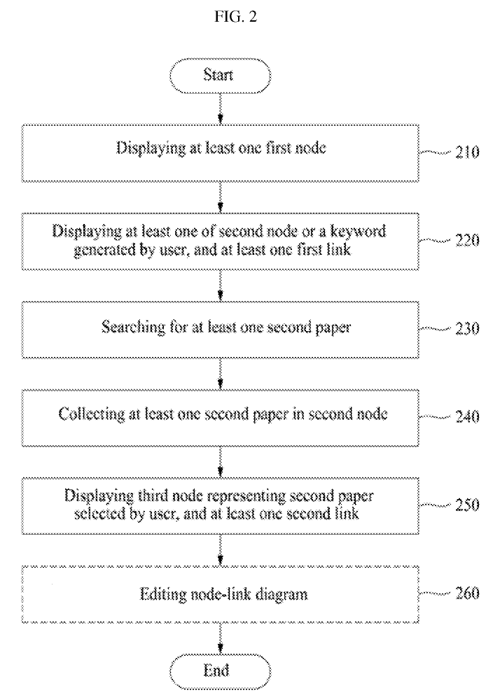

FIG. 1 is a block diagram illustrating an electronic device 100 according to various embodiments.

Referring to FIG. 1, the electronic device 100 for searching and organizing vast papers with a node-link diagram may be provided. The electronic device 100 may include at least one of a camera module 110, a communication module 120, an input module 320, a display module 140, an audio module 150, a memory 160, or a processor 170. In some embodiments, at least one of the components of the electronic device 100 may be omitted, and at least one other component may be added to the electronic device 100. In some embodiments, at least two of the components of the electronic device 100 may be implemented as one integrated circuit. In some embodiments, the electronic device 100 may be implemented as a near-eye display (NED) device wearable on a user’s face or head. For example, the near-eye display device may include at least one of smart glasses or a head mount display (HMD) device.

The camera module 110 may photograph an image. In some embodiments, when the electronic device 100 is implemented as the near-eye display device, the camera module 110 may photograph an image of a front with respect to the user wearing the electronic device 100. For example, the camera module 110 may include at least one lens, at least one image sensor, at least one image signal processor, and at least one flash.

The communication module 120 may perform communication with an external device (not shown) in the electronic device 100. The communication module 120 may establish a communication channel between the electronic device 100 and the external device, and perform communication with the external device through the communication channel. For example, the external device may include at least one of a server, a database, a base station, a satellite, or another electronic device. The communication module 120 may include at least any one of a wired communication module or a wireless communication module. For example, the wireless communication module may perform communication with the external device through at least any one of a long-distance communication network or a short-distance communication network.

The input module 130 may input a signal to be used for at least one component of the electronic device 100. The input module 130 may be configured to detect a signal directly input by the user, or to generate a signal by sensing a change in surroundings. In some embodiments, the input module 130 may include at least one of a microphone, at least one physical button, or an input device. The input device may be configured to detect a contact by the user’s hand, that is, an interaction, and to generate an interaction signal in response thereto. Here, the input device may include at least one of an interaction circuitry set to detect the interaction or a sensor circuitry set to measure a strength of a force generated by the interaction.

The display module 140 may visually output information to the outside of the electronic device 100. Specifically, the display module 140 may be configured to display visual content. At this time, the display module 140 may be combined with the input device of the input module 130 to be implemented in the form of an interaction screen, or may be disposed separately from the input device of the input module 130. In some embodiments, when the electronic device 100 is implemented as the near-eye display device, the display module 140 may be disposed in front of eyes of the user wearing the electronic device 100. The display module 140 may have a different display method depending on a type of the electronic device 100. As an example, when the electronic device 100 is an optical see-through type, at least a portion of the display module 140 is composed of a transparent or translucent material, and the user may directly see a real environment through the display module 140. In this case, as the display module 140 displays the visual content, the user may see the real environment and the visual content together. As another example, when the electronic device 100 is a video see-through type, the user may see the image of the real environment photographed through the camera module 110 through the display module 140. In this case, as the display module 140 displays the visual content, the user may see the image of the real environment and the visual content together.

The audio module 150 may aurally output information to the outside of the electronic device 100. For example, the audio module 150 may include at least one of a speaker or a receiver.

The memory 160 may store various data used by at least one component of the electronic device 100. For example, the memory 160 may include at least one of a volatile memory or a non-volatile memory. The data may include at least one program and input data or output data related thereto. The program may be stored in the memory 160 as software including at least one instruction, and may include at least one of an operating system, middleware, or an application.

The processor 170 may execute the program of the memory 160 to control at least one component of the electronic device 100. Through this, the processor 170 may perform data processing or calculation. At this time, the processor 170 may execute the instruction stored in the memory 160.

According to various embodiments, the processor 170 may search and organize vast papers with the node-link diagram based on interaction with the user. At this time, the processor 170 interacts with the user through the display module 140 and the input module 130, and may detect a user input of the user through the input device of the input module 130. Here, the user input may be generated through a body part of the user, for example, a finger, a stylus pen, or a standard input device such as a mouse or a keyboard. In the node-link diagram, each node represents a paper, and a link connecting two nodes may represent a citation relationship of papers respectively corresponding to the two nodes. Here, each node is displayed as a thumbnail of an arbitrary page of the paper, for example, a first page, and each link may be displayed as an arrow heading from one of the two nodes to the other of the two nodes.

Specifically, the processor 170 may display at least one first node respectively representing at least one first paper. The processor 170 may display a second node representing a desired paper generated by the user and at least one link respectively representing a citation relationship of the at least one first paper and the desired paper between the at least one first node and the second node, that is, a first link. The processor 170 may search for at least one second paper corresponding to the citation relationship as the desired paper, and collect the at least one second paper in the second node. When the at least one first link includes at least one arrow heading from the second node to the at least one first node, the at least one second paper may include all papers citing the at least one first paper. When the at least one first link includes an arrow heading from the at least one first node to the second node, the at least one second paper may include all papers cited by the at least one first paper.

Additionally, when the user selects the second node, the processor 170 may display a list of the at least one second paper. When the user moves one second paper from the list, the processor 170 may display a third node representing the one second paper and at least one second link respectively representing a citation relationship of the at least one first paper and the one second paper between the at least one first node and the third node. Alternatively or additionally, the processor 170 may edit the node-link diagram based on the user input of the user. Specifically, the processor 170 may expand, change, or remove the third node or the at least one second link.

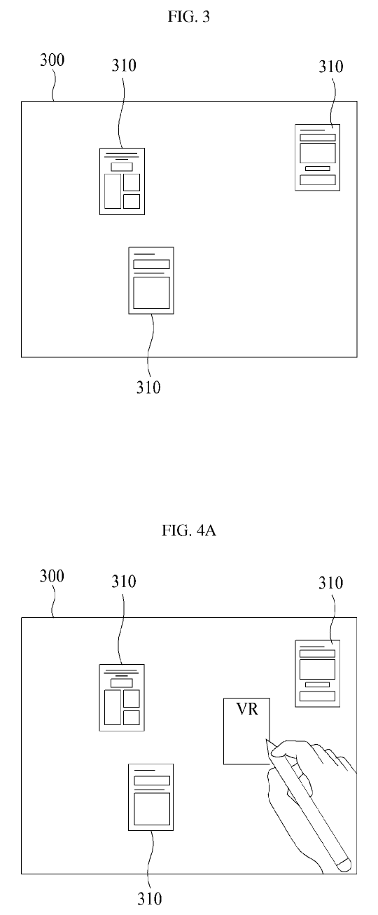

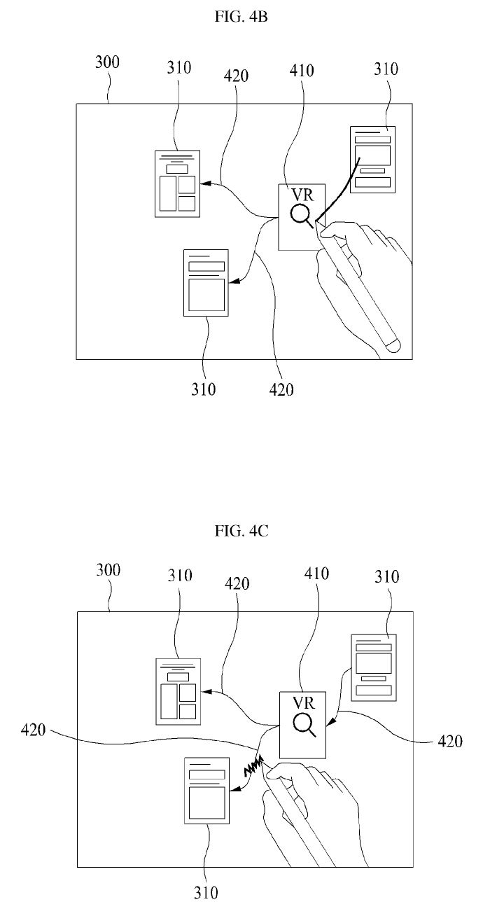

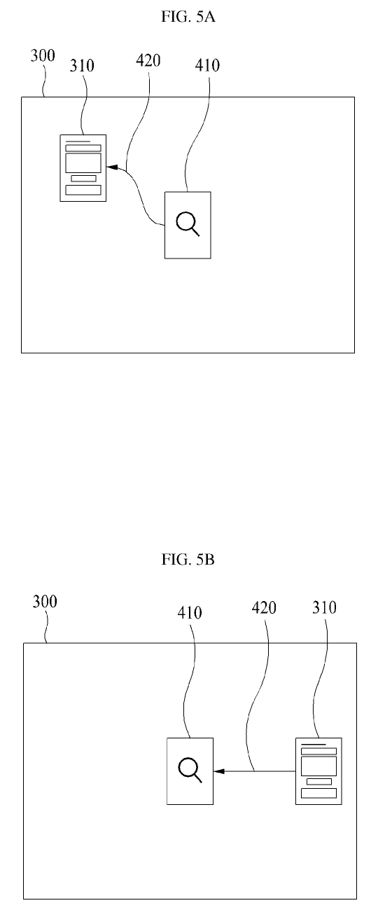

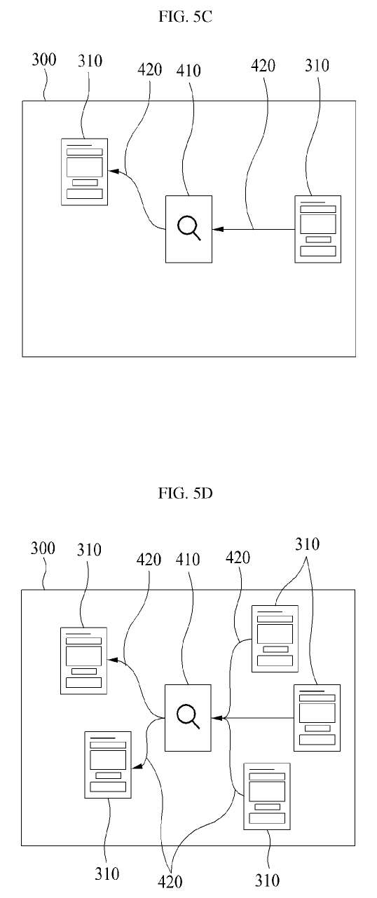

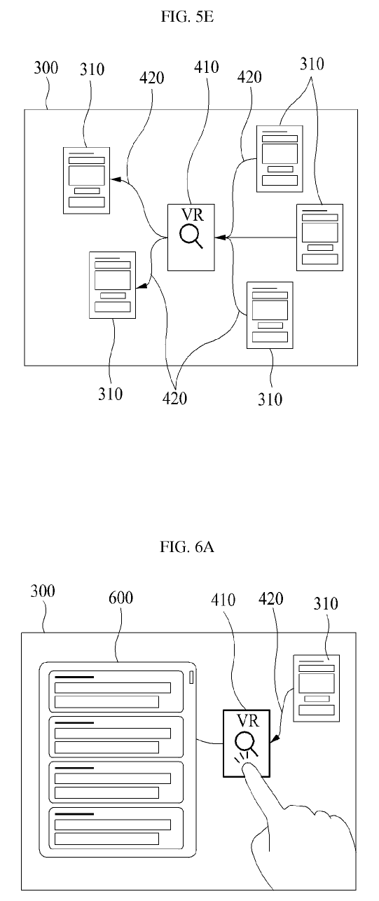

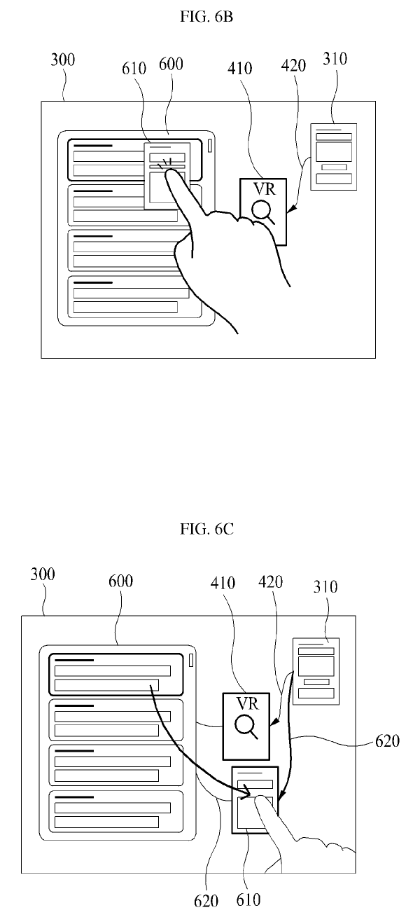

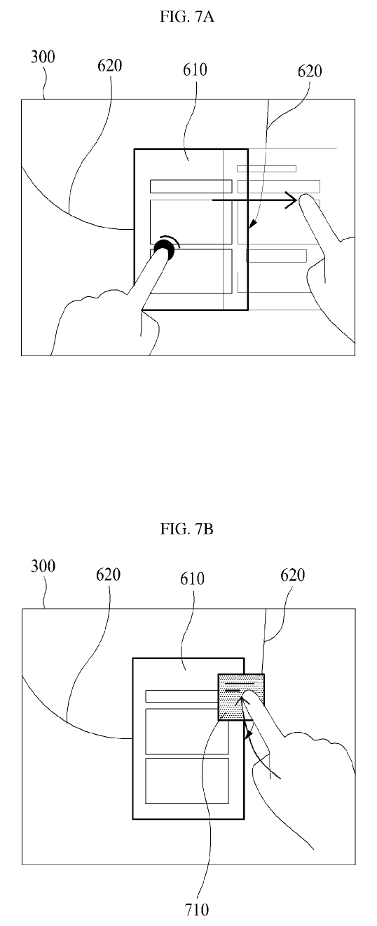

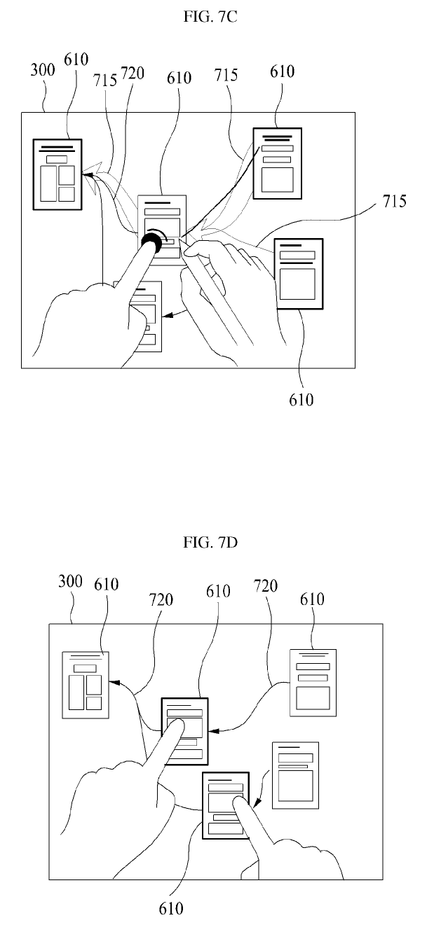

FIG. 2 is a block diagram illustrating a method of operating the electronic device 100 according to various embodiments. FIG. 3, FIG. 4A, FIG. 4B, FIG. 4C, FIG. 5A, FIG. 5B, FIG. 5C, FIG. 5D, FIG. 5E, FIG. 6A, FIG. 6B, FIG. 6C, FIG. 7A, FIG. 7B, FIG. 7C, and FIG. 7D are exemplary views for describing the method of operating the electronic device 100 according to various embodiments.

Referring to FIG. 2, first, in step 210, the electronic device 100 may display at least one first node 310. Specifically, as illustrated in FIG. 3, the processor 170 may display the at least one first node 310 on a display screen 300. The at least one first node 310 respectively represents the at least one first paper, and the at least one first paper may correspond to a seed paper highly related to the research of the user. Here, each first node 310 may be displayed as a thumbnail of one page of each first paper, for example, the first page.

More specifically, as the user determines the at least one first paper, the processor 170 may display the at least one first node 310 on the display screen 300. As an example, the processor 170 may arbitrarily arrange the at least one first node 310 on the display screen 300. As another example, after the processor 170 arbitrarily arranges the at least one first node 310 on the display screen 300, as the user moves one first node 310, the processor 170 may move the one first node 310 on the display screen 300, and in this manner, the processor 170 may respectively arrange the at least one first node 310 on the display screen 300. As another example, as the user directly designates each position of the at least one first node 310 on the display screen 300, the processor 170 may respectively arrange the at least one first node 310 on the display screen 300.

Next, in step 220, the electronic device 100 may display at least one of second node 410 or a keyword generated by the user, and at least one first link 420. Specifically, the processor 170 may display at least one of the second node 410 or the keyword, and the at least one first link 420 on the display screen 300 based on the user input of the user. The second node 410 may represent the paper desired by the user, that is, the paper to be searched for. Here, the second node 410 may be displayed including a predetermined indicator. The keyword may represent a core word included in the desired paper. Here, the keyword may be displayed corresponding to the second node 410, for example, inside the second node 410 or adjacent to the second node 410. The at least one first link 420 may respectively represent the citation relationship of the at least one first paper and the desired paper between the at least one first node 310 and the second node 410. Here, the at least one first link 420 may be displayed as an arrow.

More specifically, as illustrated in FIG. 4A, when the user draws a predetermined FIGURE(e.g., a quadrangle) at an arbitrary position on the display screen 300, as illustrated in FIG. 4B, the processor 170 may display the second node 410 corresponding to the figure on the display screen 300. At this time, the user may draw only the figure, or draw the keyword together with the figure. In some embodiments, when the user draws the keyword (e.g., VR) together with the figure, the processor 170 may display the keyword corresponding to the second node 410 while displaying the second node 410. As an example, the user may draw the keyword and then draw the figure to surround the keyword. As another example, the user may draw the figure and then draw the keyword within the figure.

Then, as illustrated in FIG. 4B, when the user draws at least one line connecting the at least one first node 310 and the second node 410 on the display screen 300, the processor 170 may display the at least one first link 420 corresponding to the at least one line on the display screen 300. Here, the at least one first link 420 may be respectively generated as an arrow heading from one of the one first node 310 or the second node 410 to the other of the one first node 310 or the second node 410. As an example, when the user draws a line from the first node 310 to the second node 410, the first link 420 may be generated as an arrow heading from the first node 310 to the second node 410. As another example, when the user draws a line from the second node 410 to the first node 310, the first link 420 may be generated as an arrow heading from the second node 410 to the first node 310.

Alternatively or additionally, as illustrated in FIG. 4C, based on the input of the user, the processor 170 may remove the at least one first link 420 between the at least one first node 310 and the second node 410. For example, when the user inputs a predetermined user input to an arbitrary first link 420 or draws a predetermined symbol, figure, texture, or the like, the processor 170 may remove the corresponding first link 420.

Next, in step 230, the electronic device 100 may search for the at least one second paper. The at least one second paper may represent a search result corresponding to the desired paper. Specifically, the processor 170 may search for the at least one second paper corresponding to the citation relationship of the at least one first link 420 as the desired paper of the second node 410. In some embodiments, when there is the keyword, the processor 170 may search for the at least one second paper corresponding to the citation relationship and including the keyword. In one embodiment, the processor 170 may search for the at least one second paper from an external server or a database thereof through the communication module 120. In another embodiment, the processor 170 may search for the at least one second paper from an internal database of the memory 160.

More specifically, the processor 170 may confirm the citation relationship of the first paper and the desired paper from the at least one first link 420 of the display screen 300, and search for the at least one second paper based on the citation relationship. As illustrated in FIG. 5A, when one first link 420 is an arrow heading from the second node 410 to one first node 310, the at least one second paper may include every paper citing the first paper of the one first node 310. As illustrated in FIG. 5B, when one first link 420 is an arrow heading from one first node 310 to the second node 410, the at least one second paper may include all papers cited by the first paper of the one first node 310. As illustrated in FIG. 5C, when two first links 420 include an arrow heading from one first node 310 to the second node 410 and an arrow heading from the second node 410 to another first node 310, the at least one second paper may include all papers cited by the first paper of the one first node 310 while citing the first paper of the another first node 310. As illustrated in FIG. 5D, when a plurality of first links 420 include arrows heading from a plurality of first nodes 310 to the second node 410 and arrows heading from the second node 410 to another plurality of first nodes 310, the at least one second paper may include all papers cited together by the first papers of the plurality of first nodes 310 while citing all of the first papers of the another plurality of first nodes 310. As illustrated in FIG. 5E, when a plurality of first links 420 include arrows heading from a plurality of first nodes 310 to the second node 410 and arrows heading from the second node 410 to another plurality of first nodes 310 while there is the keyword, the at least one second paper may include all papers cited together by the first papers of the plurality of first nodes 310 while citing all of the first papers of the another plurality of first nodes 310, as well as including the keyword.

Next, in step 240, the electronic device 100 may collect the at least one second paper in the second node 410. Specifically, the processor 170 may collect the at least one second paper in the second node 410. At this time, the processor 170 may generate a list 600 of the at least one second paper. As illustrated in FIG. 6A, when the user selects the second node 410, the processor 170 may display the list 600 of the at least one second paper. Thereby, the user may check the list 600 of the at least one second paper corresponding to the desired paper.

Next, in step 250, the electronic device 100 may display a third node 610 representing the second paper selected by the user, and at least one second link 620. Specifically, the processor 170 may display the third node 610 and the at least one second link 620 on the display screen 300 based on the user input of the user. The third node 610 may individually represent one second paper. Here, the third node 610 may be displayed as a thumbnail of one page of the corresponding second paper, for example, the first page. The at least one second link 620 may respectively represent the citation relationship of the at least one first paper and the corresponding second paper between the at least one first node 310 and the third node 610. Here, the at least one second link 620 may be displayed as an arrow.

More specifically, as illustrated in FIG. 6B and FIG. 6C, when the user selects one second paper from the list 600 of the at least one second paper and drags it to an arbitrary position on the display screen 300, the processor 170 may display the third node 610 at the corresponding position on the display screen 300. In addition, the processor 170 may display the at least one second link 620 connecting the at least one first node 310 and the third node 610 on the display screen 300. Here, the at least one second link 620 may be respectively generated as an arrow heading from one of the one first node 310 or the third node 610 to the other of the one first node 310 or the third node 610. At this time, the at least one second link 620 may be derived from the at least one first link 420. That is, the processor 170 may confirm the citation relationship of the at least one first paper of the at least one first node 310 and the corresponding second paper from the at least one first link 420, and generate the at least one second link 620 based on the citation relationship.

Alternatively or additionally, although not illustrated, based on the input of the user, the processor 170 may remove the at least one second link 620 between the at least one first node 310 and the third node 610. For example, when the user inputs a predetermined user input to an arbitrary second link 620 or draws a predetermined symbol, figure, texture, or the like, the processor 170 may remove the corresponding second link 620.

As such, the electronic device 100 may search for the desired paper from the seed paper, that is, the at least one second paper from the at least one first paper, with the node-link diagram, and organize the at least one first paper and the at least one second paper into the node-link diagram. Therefore, the electronic device 100 may generate the node-link diagram based on the at least one first paper and the at least one second paper. Thereby, the user may accurately and easily grasp the at least one second paper as the desired paper without omission through the node-link diagram, and accurately and easily grasp the big picture formed by the at least one first paper and the at least one second paper.

Alternatively or additionally, in step 260, the electronic device 100 may edit the node-link diagram based on the user input of the user. Specifically, the processor 170 may expand, change, or remove the third node 610 or the at least one second link 620 on the display screen 300 so that the user can manually author a layout and a graph topology of the node-link diagram. For example, when the user moves the third node 610, the processor 170 may move the third node 610 to a new position on the display screen 300. In addition, similarly to removing the link, when the user inputs a predetermined user input to the third node 610 or draws a predetermined symbol (e.g., an X mark), the processor 170 may remove the corresponding third node 610 from the display screen 300.

As an example, as illustrated in FIG. 7A, when the user drags another interaction while maintaining one interaction on the third node 610 of the display screen 300, the processor 170 may change the displayed page of the corresponding second paper within the third node 610. As another example, as illustrated in FIG. 7B, when the user sketches a predetermined FIGURE(e.g., a quadrangle) on the display screen 300 and generates text within the figure, the processor 170 may attach a memo 710 composed of the figure and the text to the displayed page of the corresponding second paper. Here, when the user selects the memo 710 and drags it to an arbitrary position on the displayed page of the corresponding second paper, the processor 170 may attach the memo 710 at the corresponding position. As another example, as illustrated in FIG. 7C, when the user maintains one interaction on one of the plurality of third nodes 610, the processor 170 may guide at least one candidate link 715 representing the citation relationship of the second paper of one of the third nodes 310 and the second paper of the rest of the third nodes 310 between the one of the third nodes 310 and the rest of the third nodes 610. And, when the user draws a line along an arbitrary candidate link 715, the processor 170 may display a third link 720 corresponding to the candidate link 715. Additionally, although not illustrated, based on the input of the user, the processor 170 may remove the rest of the candidate links 715. In addition, as illustrated in FIG. 7D, when the user selects another one of the plurality of third nodes 610 while selecting one of the plurality of third nodes 610, the processor 170 may simultaneously select the second papers respectively corresponding to the one of the plurality of third nodes 610 and the another one of the plurality of third nodes 610.

In short, the present disclosure provides an interaction device and method for searching and organizing vast papers with a node-link diagram.

In the present disclosure, the method of operating the electronic device 100 may include displaying the at least one first node 310 respectively representing the at least one first paper (step 210), displaying the second node 410 representing the desired paper generated by the user and the at least one link respectively representing the citation relationship of the at least one first paper and the desired paper between the at least one first node 310 and the second node 410, that is, the first link 420 (step 220), searching for the at least one second paper corresponding to the citation relationship as the desired paper (step 230), and collecting the at least one second paper in the second node 410 (step 240).

In various embodiments, the second node 410 may be generated as a predetermined figure.

In various embodiments, the at least one first link 420 may respectively connect the at least one first node 310 and the second node 410, and may be respectively generated as an arrow heading from one of the one first node 310 or the second node 410 to the other of the one first node 310 or the second node 410.

In various embodiments, when the at least one first link 420 includes at least one arrow heading from the second node 410 to the at least one first node 310, the at least one second paper may include all papers citing the at least one first paper.

In various embodiments, when the at least one first link 420 includes an arrow heading from the at least one first node 310 to the second node 410, the at least one second paper may include all papers cited by the at least one first paper.

In various embodiments, the step of displaying the second node 410 and the at least one first link 420 (step 220) may include, when the keyword is generated together with the second node 410 by the user, displaying the keyword corresponding to the second node 410 while displaying the second node 410, and when the at least one first link 420 is generated by the user, displaying the at least one first link 420.

In various embodiments, the step of searching for the at least one second paper (step 230) may include searching for the at least one second paper corresponding to the citation relationship and including the keyword.

In various embodiments, the method of operating the electronic device 100 may further include displaying the list 600 of the at least one second paper when the user selects the second node 410, and displaying the third node 610 representing the one second paper and the at least one link respectively representing the citation relationship of the at least one first paper and the one second paper between the at least one first node 310 and the third node 610, that is, the second link 620 (step 250), when the user moves one second paper from the list 600.

In various embodiments, the method of operating the electronic device 100 may further include displaying one page of the one second paper within the third node 610, and at least one of changing the displayed page of the one second paper within the third node 610 when the user drags another interaction while maintaining one interaction on the third node 610, or attaching the memo composed of the figure and the text to the displayed page of the one second paper when the user sketches a predetermined figure and generates text within the sketched figure.

In various embodiments, the method of operating the electronic device 100 may further include displaying the at least one link representing the citation relationship of the second paper of one of the third nodes 610 and the second paper of the rest of the third nodes 610 between the one of the third nodes 610 and the rest of the third nodes 610, that is, the candidate link 715, when the user maintains one interaction on one of the plurality of third nodes 610, and displaying at least a portion of the candidate link 715 as at least one actual link, that is, the third link 720, based on the input of the user.

In various embodiments, the method of operating the electronic device 100 may further include removing the at least one first link 420 between the at least one first node 310 and the second node 410, or removing the at least one second link 620 between the at least one first node 310 and the third node 610, based on the input of the user.

In various embodiments, the method of operating the electronic device 100 may further include simultaneously selecting the second papers respectively corresponding to the one of the plurality of third nodes 610 and the another one of the plurality of third nodes 610 when the user selects another one of the plurality of third nodes 610 while selecting one of the plurality of third nodes 610.

In the present disclosure, the electronic device 100 includes the display module 140, the input module 130 for detecting user input, and the processor 170 connected to the display module 140 and the input module 130 and configured to interact with the user through the display module 140 and the input module 130, and the processor 170 may be configured to display the at least one first node 310 respectively representing the at least one first paper, display the second node 410 representing the desired paper generated by the user and the at least one link respectively representing the citation relationship of the at least one first paper and the desired paper between the at least one first node 310 and the second node 410, that is, the first link 420, search for the at least one second paper corresponding to the citation relationship as the desired paper, and collect the at least one second paper in the second node 410.

In various embodiments, the second node 410 may be generated as a predetermined figure.

In various embodiments, the at least one first link 420 may respectively connect the at least one first node 310 and the second node 410, and may be respectively generated as an arrow heading from one of the one first node 310 or the second node 410 to the other of the one first node 310 or the second node 410.

In various embodiments, when the at least one first link 420 includes at least one arrow heading from the second node 410 to the at least one first node 310, the at least one second paper may include all papers citing the at least one first paper.

In various embodiments, when the at least one first link 420 includes an arrow heading from the at least one first node 310 to the second node 410, the at least one second paper may include all papers cited by the at least one first paper.

In various embodiments, the processor 170 may be configured to display the list 600 of the at least one second paper when the user selects the second node 410, and display the third node (610) representing the one second paper and the at least one link respectively representing the citation relationship of the at least one first paper and the one second paper between the at least one first node 310 and the third node 610, that is, the second link 620, when the user moves one second paper from the list 600.

In the present disclosure, in a computer program stored in a non-transitory computer-readable recording medium to execute the method of expressing the cited papers with node-link diagram in the electronic device 100, the method may include displaying the at least one first node 310 respectively representing the at least one first paper, displaying the second node 410 representing the desired paper generated by the user and the at least one link respectively representing the citation relationship of the at least one first paper and the desired paper between the at least one first node 310 and the second node 410, that is, the first link 420, searching for the at least one second paper corresponding to the citation relationship as the desired paper, and collecting the at least one second paper in the second node 410.

According to the present disclosure, the electronic device 100 may search for the desired paper from the seed paper, that is, the at least one second paper from the at least one first paper, with the node-link diagram based on the interaction with the user, and organize the at least one first paper and the at least one second paper into the node-link diagram. Therefore, the electronic device 100 may generate the node-link diagram based on the at least one first paper and the at least one second paper. Thereby, the user may accurately and easily grasp the at least one second paper as the desired paper without omission through the node-link diagram, and accurately and easily grasp the big picture formed by the at least one first paper and the at least one second paper. Alternatively or additionally, the electronic device 100 may easily edit the node-link diagram based on the interaction with the user.

The system described above may be implemented as a hardware component, a software component, and/or a combination of the hardware component and the software component. For example, the system and the component described in the embodiments may be implemented using one or more general-purpose computers or special-purpose computers, such as a processor, a controller, an arithmetic logic unit (ALU), a digital signal processor, a microcomputer, a field programmable gate array (FPGA), a programmable logic unit (PLU), a microprocessor, or any other device capable of executing and responding to an instruction. A processing device may execute an operating system (OS) and one or more software applications executed on the operating system. In addition, the processing device may access, store, manipulate, process, and generate data in response to the execution of the software. For convenience of understanding, the processing device has been described as being used as one in some cases, but those of ordinary skill in the art may recognize that the processing device may include a plurality of processing elements and/or a plurality of types of processing elements. For example, the processing device may include a plurality of processors or one processor and one controller. In addition, other processing configurations, such as a parallel processor, are also possible.

The software may include a computer program, a code, an instruction, or a combination of one or more thereof, and may configure the processing device to operate as desired or command the processing device independently or collectively. The software and/or the data may be embodied in any type of machine, component, physical device, computer storage medium, or device in order to be interpreted by the processing device or to provide an instruction or data to the processing device. The software may be distributed on a computer system connected through a network, and stored or executed in a distributed manner. The software and the data may be stored in one or more computer-readable recording media.

The method according to various embodiments may be implemented in the form of a program instruction that may be performed through various computer means and recorded in a computer-readable medium. At this time, the medium may continuously store a computer-executable program, or temporarily store it for execution or download. And, the medium may be various recording means or storage means in the form of a single or a combination of several hardwares, and is not limited to a medium directly connected to a certain computer system, but may be distributed on a network. Examples of the medium may include a magnetic medium such as a hard disk, a floppy disk, and a magnetic tape, an optical recording medium such as a CD-ROM and a DVD, a magneto-optical medium such as a floptical disk, and those configured to store a program instruction including a ROM, a RAM, a flash memory, and the like. In addition, as an example of another medium, a recording medium or a storage medium managed by an app store distributing an application or a site, a server, or the like supplying or distributing various other software may be given.

Various embodiments of the present document and terms used therein are not intended to limit the technology described in the present document to a specific embodiment, and should be understood to include various modifications, equivalents, and/or substitutes of the corresponding embodiment. In connection with the description of the drawings, similar reference numerals may be used for similar components. A singular expression may include a plural expression unless the context clearly indicates otherwise. In the present document, expressions such as “A or B”, “at least one of A and/or B”, “A, B or C”, or “at least one of A, B and/or C” may include all possible combinations of the items listed together. Expressions such as “first”, “second”, “firstly”, or “secondly” may modify the corresponding components regardless of order or importance, and are only used to distinguish one component from another component and do not limit the corresponding components. When a certain (e.g., first) component is referred to as being “(functionally or communicatively) connected” or “accessed” to another (e.g., second) component, the certain component may be directly connected to the another component, or connected through another component (e.g., a third component).

The term “module” used in the present document includes a unit composed of hardware, software, or firmware, and may be used interchangeably with terms such as, for example, logic, a logic block, a part, or a circuit. The module may be an integrally configured part or a minimum unit performing one or more functions or a portion thereof. For example, the module may be configured as an application-specific integrated circuit (ASIC).

According to various embodiments, each component (e.g., a module or a program) of the described components may include a singular or a plurality of entities. According to various embodiments, one or more components or steps among the aforementioned corresponding

components may be omitted, or one or more other components or steps may be added. Alternatively or additionally, a plurality of components (e.g., modules or programs) may be integrated into one component. In this case, the integrated component may perform one or more functions of each component of the plurality of components identically or similarly to those performed by the corresponding component among the plurality of components prior to the integration. According to various embodiments, steps performed by a module, a program, or another component may be executed sequentially, in parallel, repeatedly, or heuristically, or one or more of the steps may be executed in a different order, omitted, or one or more other steps may be added.

What is claimed is:

1. A method of operating an electronic device, comprising:
displaying at least one first node respectively representing at least one first paper;
displaying a second node representing a desired paper generated by a user, and at least one link respectively representing a citation relationship between the at least one first paper and the desired paper between the at least one first node and the second node;
searching for at least one second paper corresponding to the citation relationship as the desired paper; and
collecting the at least one second paper in the second node.

2. The method of claim 1, wherein the second node is generated as a predetermined figure, and wherein the at least one link respectively connects the at least one first node and the second node, and is respectively generated as an arrow heading from one of the one first node or the second node to the other of the one first node or the second node.

3. The method of claim 2, wherein the at least one second paper comprises every papers citing the at least one first paper when the at least one link comprises at least one arrow heading from the second node to the at least one first node, and every papers cited by the at least one first paper when the at least one link comprises an arrow heading from the at least one first node to the second node.

4. The method of claim 1, wherein the displaying of the second node and the at least one link comprises:
displaying a keyword corresponding to the second node while displaying the second node, when the keyword is generated together with the second node by the user; and
displaying the at least one link, when the at least one link is generated by the user.

5. The method of claim 4, wherein the searching for the at least one second paper comprises searching for the at least one second paper that corresponds to the citation relationship and includes the keyword.

6. The method of claim 1, further comprising:
displaying a list of the at least one second paper when the user selects the second node; and
displaying a third node representing the one second paper, and at least one link respectively representing a citation relationship between the at least one first paper and the one second paper between the at least one first node and the third node, when the user moves the one second paper from the list.

7. The method of claim 6, further comprising:
displaying a page of the one second paper within the third node; and
at least one of changing the displayed page of the one second paper within the third node, or attaching a memo consisting of a figure and text to the displayed page of the one second paper when the user sketches the predetermined figure and generates the text within the sketched figure.

8. The method of claim 6, further comprising:
displaying at least one candidate link representing a citation relationship between a second paper of the one of the third nodes and a second paper of the rest of the third nodes between one of a plurality of third nodes and the rest of the third nodes, when the user maintains one interaction on the one of the plurality of third nodes; and
displaying at least a part of the at least one candidate link as at least one actual link based on an input of the user.

9. The method of claim 6, further comprising:
moving a position of the third node on the display screen based on an input of the user; or
removing the third node or at least one link between the at least one first node and the second node or between the at least one first node and the third node based on an input of the user.

10. The method of claim 6, further comprising: simultaneously selecting second papers respectively corresponding to one of a plurality of third nodes and another one of the plurality of third nodes, when the user selects the another one of the plurality of third nodes while selecting the one of the plurality of third nodes.

11. An electronic device, comprising:
a display module;
an input module for detecting a user input; and
a processor connected to the display module and the input module, and configured to interact with a user through the display module and the input module,
wherein the processor is configured to:
display at least one first node respectively representing at least one first paper;
display a second node representing a desired paper generated by the user, and at least one link respectively representing a citation relationship between the at least one first paper and the desired paper between the at least one first node and the second node;
search for at least one second paper corresponding to the citation relationship as the desired paper; and
collect the at least one second paper in the second node.

12. The electronic device of claim 11, wherein the second node is generated as a predetermined figure, and wherein the at least one link respectively connects the at least one first node and the second node, and is respectively generated as an arrow heading from one of one first node or the second node to the other of the one first node or the second node.

13. The electronic device of claim 12, wherein the at least one second paper comprises: every papers citing the at least one first paper when the at least one link comprises at least one arrow heading from the second node to the at least one first node, and every papers cited by the at least one first paper when the at least one link comprises an arrow heading from the at least one first node to the second node.

14. The electronic device of claim 11, wherein the processor is configured to:
display a list of the at least one second paper when the user selects the second node; and
display a third node representing one second paper, and at least one link respectively representing a citation relationship between the at least one first paper and the one second paper between the at least one first node and the third node, when the user moves the one second paper from the list.

15. The electronic device of claim 14, wherein the processor is configured to:
move a position of the third node on the display screen based on an input of the user; or
remove the third node or at least one link between the at least one first node and the second node or between the at least one first node and the third node based on an input of the user.

16. A non-transitory computer-readable recording medium storing a computer program to execute a method of expressing cited papers with a node-link diagram in an electronic device, comprising:
displaying at least one first node respectively representing at least one first paper;
displaying a second node representing a desired paper generated by a user, and at least one link respectively representing a citation relationship between the at least one first paper and the desired paper between the at least one first node and the second node;
searching for at least one second paper corresponding to the citation relationship as the desired paper; and
collecting the at least one second paper in the second node.
